(19) United States
(12) Patent Application Publication
(10) Pub. No.: US 2011/0234611 A1
(43) Pub. Date: Sep. 29, 2011

(54) METHOD AND APPARATUS FOR PROCESSING IMAGE IN HANDHELD DEVICE

(75) Inventors: Nitin Singhal, Suwon-si (KR); Sung-Dae Cho, Yongin-si (KR); Chung-Hoon Kim, Seongnam-si (KR); Abhinav Arora, Suwon-si (KR); Yoon-Choon Hwang, Incheon (KR)

(73) Assignee: Samsung Electronics Co., Ltd., Suwon-si (KR)

(21) Appl. No.: 13/073,484

(22) Filed: Mar. 28, 2011

(30) Foreign Application Priority Data
Mar. 26, 2010 (KR) 10-2010-0027505

(51) Int. Cl. G06K 9/32; G09G 5/00

(52) U.S. Cl. 345/582; 382/299

(57) ABSTRACT

A handheld device including a Central Processing Unit (CPU) for receiving an original image input into the handheld device, and converting the original image into a quadrilateral image corresponding to a display size; and a General Purpose Computing on Graphics Processing Unit (GPGPU) for setting fragments for pixels included within vertices of the quadrilateral image, and applying a predetermined algorithm for image processing to the original image.

### PRIORITY

This application claims priority under 35 U.S.C. §119(a) to an application entitled “Method and Apparatus for Processing Image in Handheld Device” filed in the Korean Intellectual Property Office on Mar. 26, 2010, and assigned Ser. No. 10-2010-0027505, the entire disclosure of which is incorporated herein by reference.

### BACKGROUND OF THE INVENTION

1. Field of the Invention

The present invention relates generally to technology for processing an image in a handheld device, and more particularly, to a method and apparatus for processing an image in a handheld device by using a General Purpose Computing on Graphics Processing Unit (GPGPU).

2. Description of the Related Art

In the early stage of the introduction of a handheld device, the handheld device was used only for the purpose of mobile voice communication. However, with the development of electronic and communication technology, various functionality has recently been implemented within a handheld device, and thus the handheld device is used as an information and communication device with various functionality, such as camera, moving picture reproduction, sound reproduction, game, image editing, and broadcast reception functions, rather than being used merely for voice communication.

When a handheld device used as an information and communication device described above performs image related functions, such as camera, image edit, moving picture reproduction, the images generated therein or received from an external source through a communication network are processed by a Central Processing Unit (CPU) of the device. Further, a high-performance CPU is required to process such images, specifically, high-quality images, but there is a limitation on the performance of an embedded CPU in view of the hardware characteristic of a handheld device. Therefore, there is a need to find a way to process high-quality images without a high-performance embedded CPU in a handheld device.

### SUMMARY OF THE INVENTION

Accordingly, the present invention has been made to solve at least the above-mentioned problems occurring in the prior art, and the present invention provides a method and apparatus for processing an image in a handheld device by applying a GPGPU to the handheld device.

According to one aspect of the present invention, there is provided a handheld device including a CPU for receiving an original image input into the handheld device, and converting the input original image into a quadrilateral image corresponding to a display size; and a GPGPU for setting fragments for pixels included within vertices of the quadrilateral image, and applying a predetermined algorithm for image processing to the original image.

In accordance with another aspect of the present invention, there is provided a method of processing an image in a handheld device, the method including receiving an original image input into the handheld device, and converting the original image into a quadrilateral image corresponding to a display size; setting fragments for pixels included within vertices of the quadrilateral image by a GPGPU; and performing image processing for each fragment of the original image by the GPGPU.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a structure of a handheld device in accordance with an embodiment of the present invention;

FIG. 2 is a block diagram illustrating a detailed architecture of a CPU and a GPGPU provided in the handheld device of FIG. 1;

FIG. 3A is a diagram illustrating a process of performing RGB-Gray conversion through a handheld device in accordance with an embodiment of the present invention;

FIG. 3B is a diagram illustrating an example of a program code for performing RGB-Gray conversion through a CPU provided in the handheld device of FIG. 3A;

FIG. 3C is a diagram illustrating an example of a program code input into a vertex processor in order to perform RGB-Gray conversion through a CPU provided in the handheld device of FIG. 3A;

FIG. 3D is a diagram illustrating an example of a program code input into a fragment processor in order to perform RGB-Gray conversion through a CPU provided in the handheld device of FIG. 3A;

FIG. 4A is a diagram illustrating a first example of a program code input into a fragment processor in order to implement a sharpening filter through a GPGPU provided in a handheld device;

FIG. 4B is a diagram illustrating a second example of a program code input into a fragment processor in order to implement a sharpening filter through a GPGPU provided in a handheld device;

FIG. 4C is a diagram illustrating a third example of a program code input into a fragment processor in order to implement a sharpening filter through a GPGPU provided in a handheld device;

FIG. 4D is a graph comparing performances between the fragment processors of FIG. 4A, FIG. 4B, and FIG. 4C;

FIG. 5A is a diagram illustrating a process of performing Sobel edge detection through a handheld device in accordance with an embodiment of the present invention;

FIG. 5B is a diagram illustrating an example of a program code input into a fragment processor of a GPGPU provided in the handheld device of FIG. 5A;

FIG. 5C is a diagram illustrating a relation between input and output coordinates of a vertex processor;

FIG. 5D is a diagram illustrating an example of a program code input into a vertex processor of a GPGPU provided in the handheld device of FIG. 5A;

FIG. 5E is a diagram illustrating another example of a program code input into a fragment processor of a GPGPU provided in the handheld device of FIG. 5A;

FIG. 6A is a diagram illustrating a process of performing real-time video scaling with detail enhancement through a handheld device in accordance with an embodiment of the present invention;

FIG. 6B is a diagram illustrating an example of weights for use in bilinear interpolation;

FIG. 6C is a graph illustrating the number of frames processed per second for different resolutions;

FIG. 7A is a diagram illustrating a process of implementing real-time video effects through a handheld device in accordance with an embodiment of the present invention;

FIG. 7B is a graph illustrating the number of frames processed per second in each real-time video effects processing for different resolutions;

FIG. 8A is a diagram illustrating a process of performing cartoon-style non-photorealistic rendering through a handheld device in accordance with an embodiment of the present invention;

FIG. 8B is a graph illustrating the number of frames processed per second in cartoon-style non-photorealistic rendering processing for different resolutions;

FIG. 9 is a diagram illustrating a process of implementing a Harris corner detector through a handheld device in accordance with an embodiment of the present invention;

FIG. 10 is a diagram illustrating a process of performing face image beautification through a handheld device in accordance with an embodiment of the present invention; and

FIG. 11 is a flowchart illustrating a procedure of performing an image processing method in a handheld device in accordance with an embodiment of the present invention.

### DETAILED DESCRIPTION OF EMBODIMENTS OF THE PRESENT INVENTION

Hereinafter, embodiments of the present invention will be described with reference to the accompanying drawings. It should be noted that the similar components are designated by similar reference numerals although they are illustrated in different drawings. Also, in the following description, a detailed description of known functions and configurations incorporated herein will be omitted to avoid obscuring the subject matter of the present invention. Further, it should be noted that only parts essential for understanding the operations according to the present invention will be described and a description of parts other than the essential parts will be omitted.

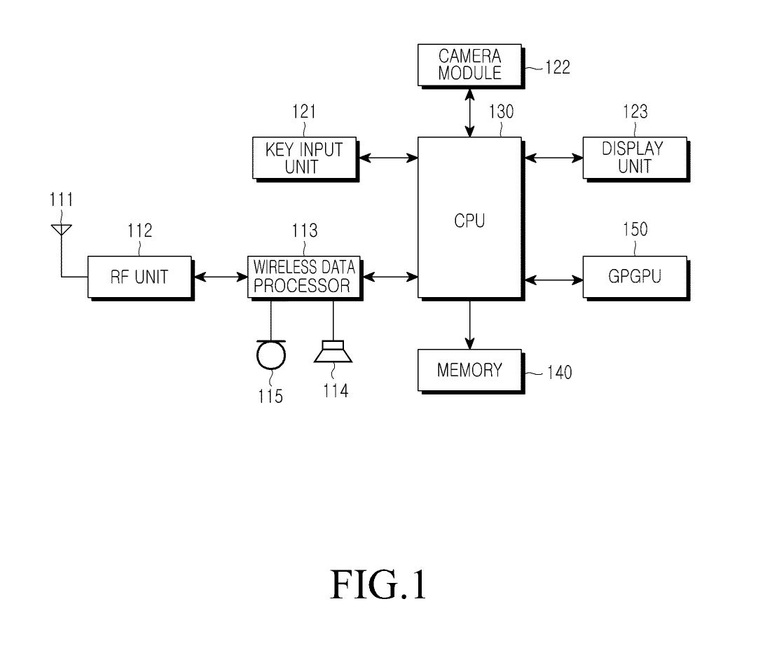

FIG. 1 illustrates a structure of a handheld device according to an embodiment of the present invention. Prior to a description of the present invention, a basic hardware apparatus to which the present invention may be applied will be first described using a mobile communication terminal as an example, among various handheld devices capable of image processing through a GPGPU provided therein. However, it will be apparent to those skilled in the art that the present invention is not limited thereto.

Referring to FIG. 1, the handheld device for processing an image by using a GPGPU includes an antenna 111, an RF unit 112, a wireless data processor 113, a key input unit 121, a camera module 122, a display unit 123, a CPU 130, a memory 140, and the GPGPU 150.

The RF unit 112 modulates user voice, text, and control data into an RF signal, transmits the modulated RF signal to a base station (not shown) of a mobile communication network through the antenna 111, receives an RF signal from the base station through the antenna 111, demodulates the received RF signal into a voice, a text, control data, or the like, and outputs the demodulated voice, text, control data, or the like. The wireless data processor 113 decodes voice data received from the RF unit 112 to output an audible sound through a speaker 114, processes user voice signal input from a microphone 115 to output data to the RF unit 112, and provides a text and control data input through the RF unit 112 to the CPU 130, under the control of the CPU 130.

The key input unit 121, is used to input a phone number or text, has keys for inputting number and character information and function keys for setting various functions, and outputs a signal input through each key to the CPU 130. The key input unit 121 may be formed by a keypad or touch screen that is typically provided in a handheld device.

The camera module 122, performs typical digital camera functions, controlled by the CPU 130, senses an image projected through a lens by an image sensor, to generate an image frame, and displays the image frame on the display unit 123 or stores the image frame in the memory 140.

The display unit 123 may be a display device, such as a Liquid Crystal Display (LCD), and displays messages about various operation states of a corresponding handheld device, image frames generated by the camera module 122, image frames stored in the memory 140, information and image frames that application programs driven by the CPU 130 generate, under the control of the CPU 130.

The CPU 130 controls the overall operation of the handheld device, that is, the mobile communication terminal, by collectively controlling the operations of the respective aforementioned functional units. More specially, the CPU 130 performs processing according to number and menu selection signals input through the key input unit 121, receives an external photographing signal input through the camera module to perform processing according thereto, and outputs image output signals required for various operations, including camera photographing images, through the display unit 121. Further, the CPU 130 stores application programs for basic functions of the handheld device in the memory 140, processes an application programs requested to be executed, stores application programs optionally installed by a user in the memory 140, and reads out and processes an application program corresponding to an execution request.

Specifically, the CPU 130 is requested to execute an application program for image processing, and provides data for image processing to the GPGPU 150 to request the GPGPU 150 to process image data. For example, data provided to the GPGPU 150 by the CPU 130 includes predetermined vertex and fragment shader programs for image processing, an original image, and a quadrilateral image. The GPGPU 150 has programmable attributes, and is implemented in such a manner as to change a pipeline function by a user. That is, the GPGPU 150 is implemented in such a manner as to change a pipeline function by the vertex and fragment shader programs provided by the CPU 130. The GPGPU 150 also identifies vertices from the quadrilateral image provided by the CPU 130, sets fragments for pixels included in an area formed within the vertices, and executes shader computations on the original image in consideration of the fragments to thereby determine the RGB value of at least one pixel included in the original image. The RGB value of the at least one pixel, determined by the GPGPU 150, is provided to the CPU 130.

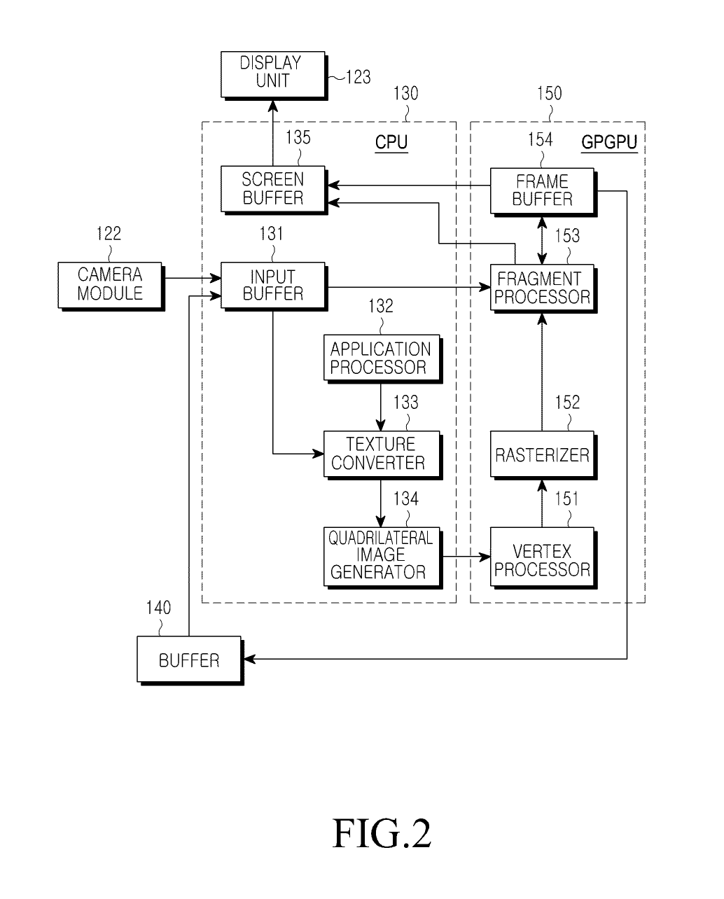

FIG. 2 illustrates a detailed structure of the CPU and GPGPU provided in the handheld device of FIG. 1. Referring to FIG. 2, the CPU 130 includes an input buffer 131, an application processor 132, a texture converter 133, a quadrilateral image generator 134, and a screen buffer 135, and the GPGPU 150 includes a vertex processor 151, a rasterizer 152, a fragment processor 153, and a frame buffer 154.

The input buffer 131 included in the CPU 130 receives an image input from the camera module 131 or the memory 140, sequentially performs buffering of the received image, and outputs the buffered image to the texture converter 133. The application processor 132 processes applications preinstalled in the handheld device, and outputs data (for example, text or image data), which is to be displayed on the display unit, to the texture converter 133. The texture converter 133 converts data provided from the application processor 132 and an image provided from the input buffer 131 into a texture format, and generates a combined image by combining the texture format-converted data and image, and provides the generated combined image to the quadrilateral image generator 134. The quadrilateral image generator 134 generates a quadrilateral image by converting the combined image in such a manner as to match to the size of the display unit 123 and the resolution of the image.

The vertex processor 151 included in the GPGPU 150 receives an attribute, a uniform, and a shader program input therein. The attribute input includes vertex data provided using a vertex array, and the uniform input includes a constant used by the vertex processor 151. The shader program includes the program source code (that is, vertex shader program source code) of the vertex processor 151, which specifies in detail operators to be executed on the vertices. Further, the vertex processor 151 transforms vertices, which are included in the quadrilateral image provided by the quadrilateral image generator 134, from the global coordinate system to the image coordinate system, and provides the transformed vertices to the rasterizer 152.

The rasterizer 152 is provided with vertices in the image coordinate system from the vertex processor 151, defines fragments for pixels that are included in an area formed by the vertices, and provides the defined fragments to the fragment processor 153.

The fragment processor 153 executes shader computations for an image provided in a texture format from the input buffer 131 of the CPU 130, based on the fragments provided by the rasterizer 152, to thereby set at least one pixel value included in the image. The fragment processor 153 receives vertices, a uniform, a texture, and a shader program input therein. The uniform input includes a state variable used by the fragment processor 153, and the texture input includes an image texture provided from the input buffer 131. The shader program includes the program source code (that is, fragment shader program source code) or binary of the fragment processor 153, which specifies in detail operators to be executed on fragments. For example, the shader program may be a fragment shader implemented in the OpenGL ES shading language.

Further, the fragment processor 153 may be implemented as a method-call function with a single rendering pass or a state-machine function with multi-pass rendering cycles. When the fragment processor 153 is implemented as a method-call function, it may provide a processed pixel value to the screen buffer 135 of the CPU 130. On the other hand, when the fragment processor 153 is implemented as a state-machine function, it performs rendering processing in a plurality of rendering cycles, and stores an intermediate output value, obtained in each rendering cycle, in a texture format in the frame buffer 154.

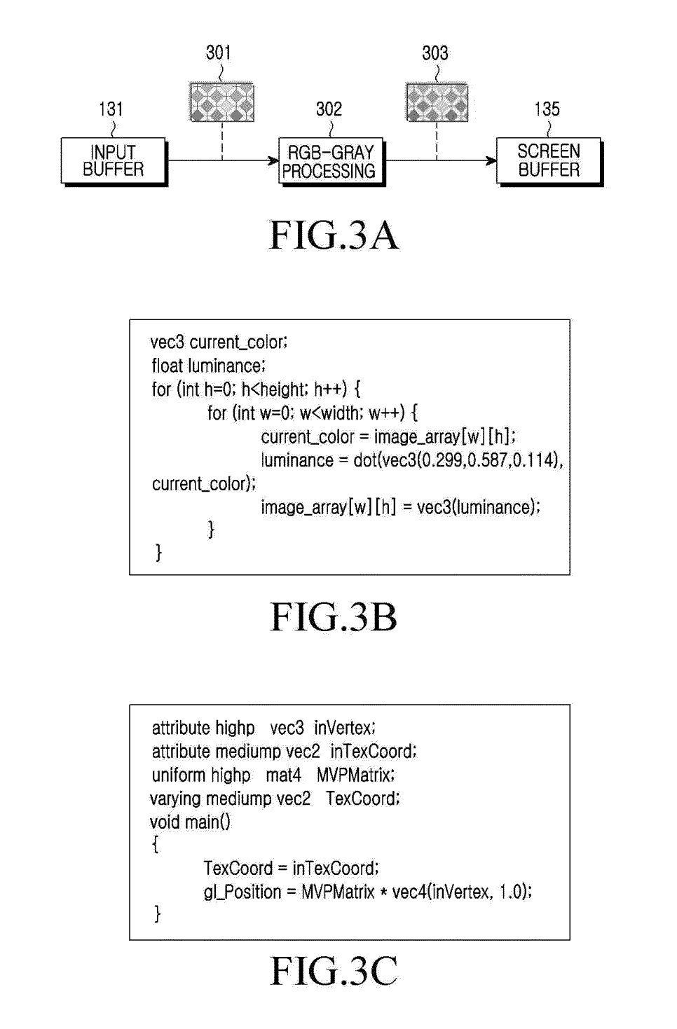

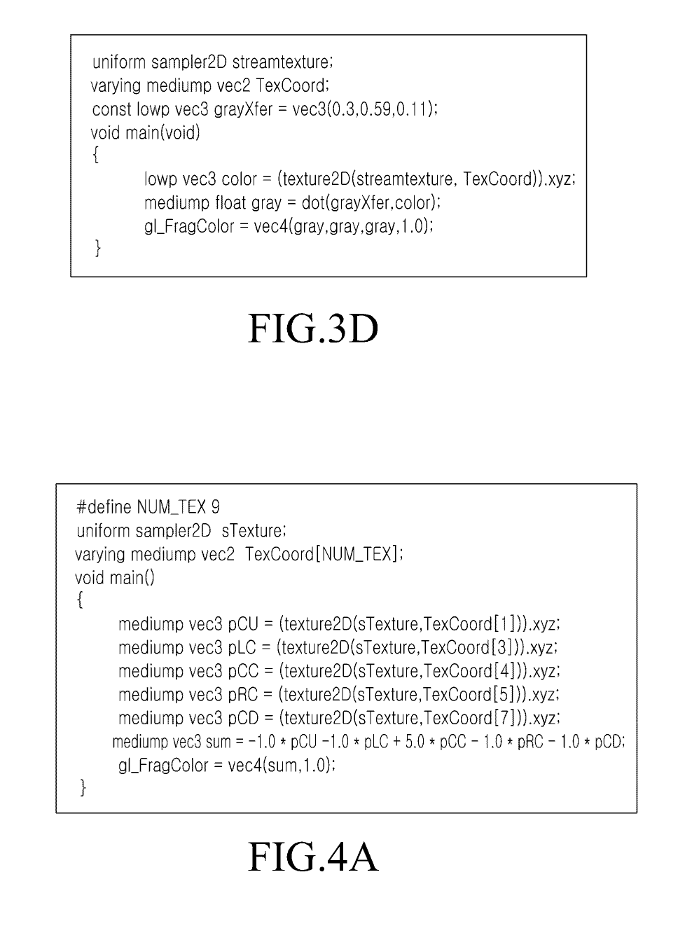

FIG. 3A illustrates a process of performing RGB-Gray conversion through a handheld device to which an image processing method according to an embodiment of the present invention is applied, FIG. 3B illustrates an example of a program code for performing RGB-Gray conversion through a CPU provided in the handheld device of FIG. 3A, FIG. 3C illustrates an example of a program code input into the vertex processor 151 in order to perform RGB-Gray conversion through the CPU provided in the handheld device of FIG. 3A, and FIG. 3D illustrates an example of a program code input into the fragment processor 153 in order to perform RGB-Gray conversion through the CPU provided in the handheld device of FIG. 3A. In order to perform RGB-Gray conversion through a CPU, each pixel of an image frame is processed in series by using a for loop, as illustrated in FIG. 3B.

In contrast to this, referring to FIG. 3A, in order to perform RGB-Gray conversion in step 302 through a GPGPU according to an embodiment of the present invention, the texture converter 133 and the quadrilateral image generator 134 of the CPU 130 convert the original image 301 into a quadrilateral image in a texture format and the vertex processor 151 of the GPGPU 150, which is compiled as a vertex shader implemented in the OpenGL ES shading language, as illustrated in FIG. 3C, transforms each vertex queued for rendering processing into the image coordinate system. The fragment processor 153, which is compiled as a fragment shader implemented in the OpenGL ES shading language, as illustrated in FIG. 3D, extracts the color of each pixel from an input image in a texture format, and converts the extracted color to a brightness value. An RGB-Gray conversion frame 303 is generated through the processes described above, of the texture converter 133, the quadrilateral image generator 134, vertex processor 151, and the fragment processor 153, and a result thereof is output to the display unit 123 through the screen buffer 135. Here, the fragment processor 153 is implemented as a method-call function with a single rendering pass. To achieve high throughput, OpenGL ES 2.0 (version 2.0 of the OpenGL ES language) supports three precision modifiers (lowp, mediump, highp). The highp modifier is represented as 32 bit floating point values, the mediump modifier is represented as 16 bit floating point values in the range [−65520, 65520], and the lowp modifier is represented as 10 bit fixed point values in the range [−2, 2]. The lowp modifier is useful to represent color values and any data read from low precision textures. Selecting a low precision can increase the performance of a handheld device, but may cause overflow. Accordingly, it is necessary to find an appropriate balance therebetween.

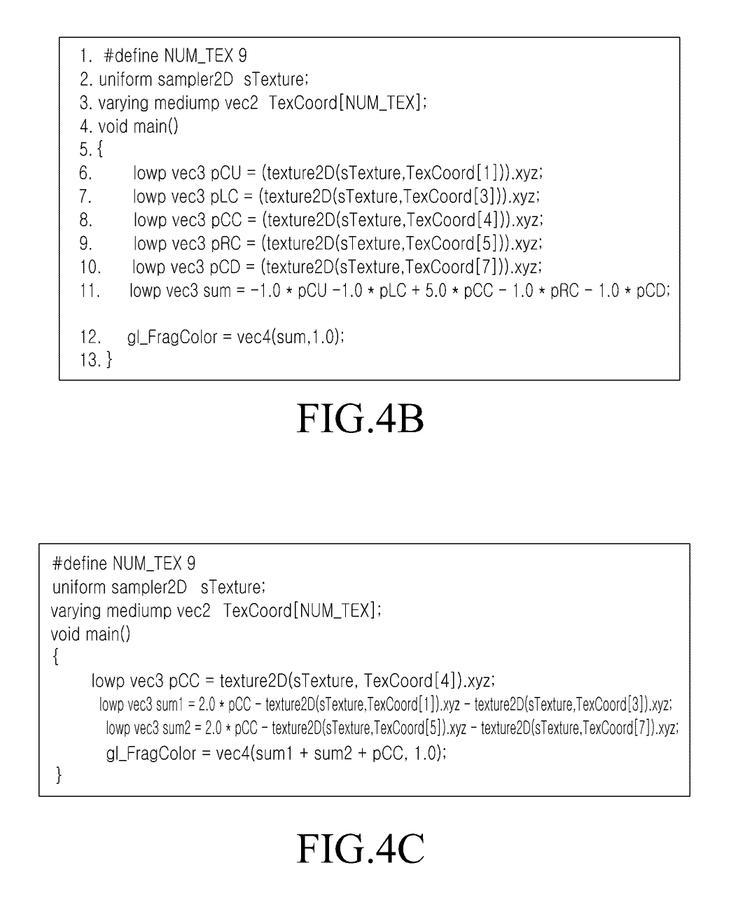

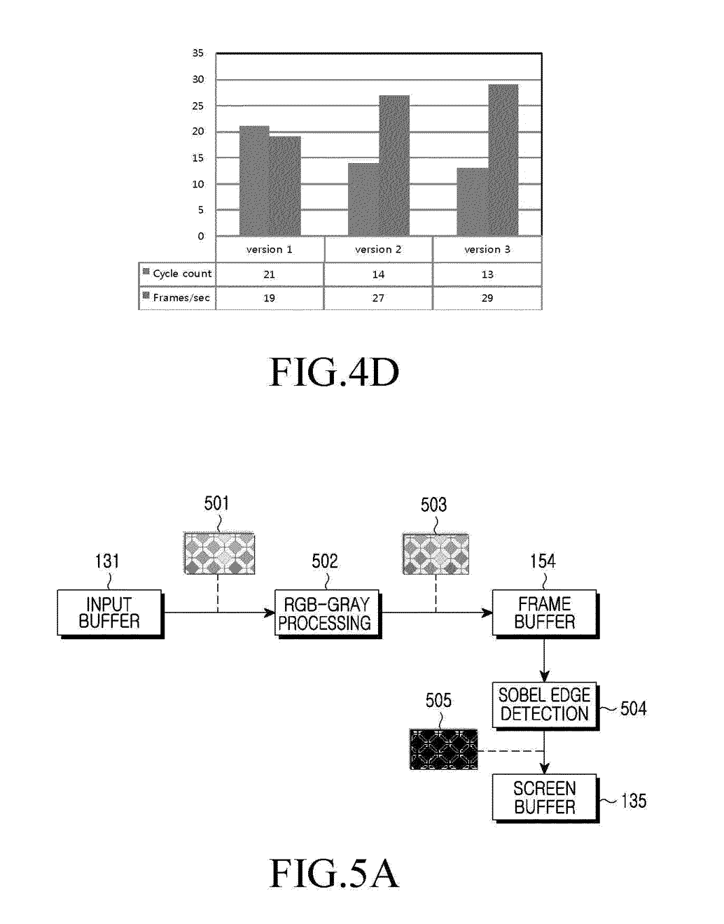

FIG. 4A illustrates a first example of a fragment shader program code for implementing a sharpening filter through a GPGPU provided in a handheld device, FIG. 4B illustrates a second example of a fragment shader program code for implementing a sharpening filter through a GPGPU provided in a handheld device, FIG. 4C illustrates a third example of a fragment shader program code for implementing a sharpening filter through a GPGPU provided in a handheld device, and FIG. 4D is a graph comparing performances between the fragment shaders of FIG. 4A, FIG. 4B, and FIG. 4C.

The fragment shader program code of FIG. 4A is implemented such that the fragment processor 153 processes every variable by using the mediump modifier, and the fragment shader program code of FIG. 4B is implemented such that the fragment processor 153 processes every variable by using the lowp modifier. However, in FIG. 4B illustrating the second example of a fragment shader program code, multiplying a low precision vector pCC by 5.0, shown in line 11, results in overflow from the low precision range. This causes the intermediate value to be clamped within [−2, 2], resulting in incorrect sum value. Accordingly, the fragment shader program code of FIG. 4C is implemented in such a manner as to be optimized for a sharpening filter so as to prevent data overflow by using low precisions for textures.

FIG. 4D illustrates results of measuring a cycle count and the number of frames processed per second at a VGA resolution of 640×480 for the program codes shown in FIG. 4A, FIG. 4B, and FIG. 4C. Referring to FIG. 4D, the program code shown in FIG. 4C has a relatively small cycle count and the relatively large number of frames processed per second. Therefore, it can be noted that the program code shown in FIG. 4C is a relatively optimized version for a sharpening filter.

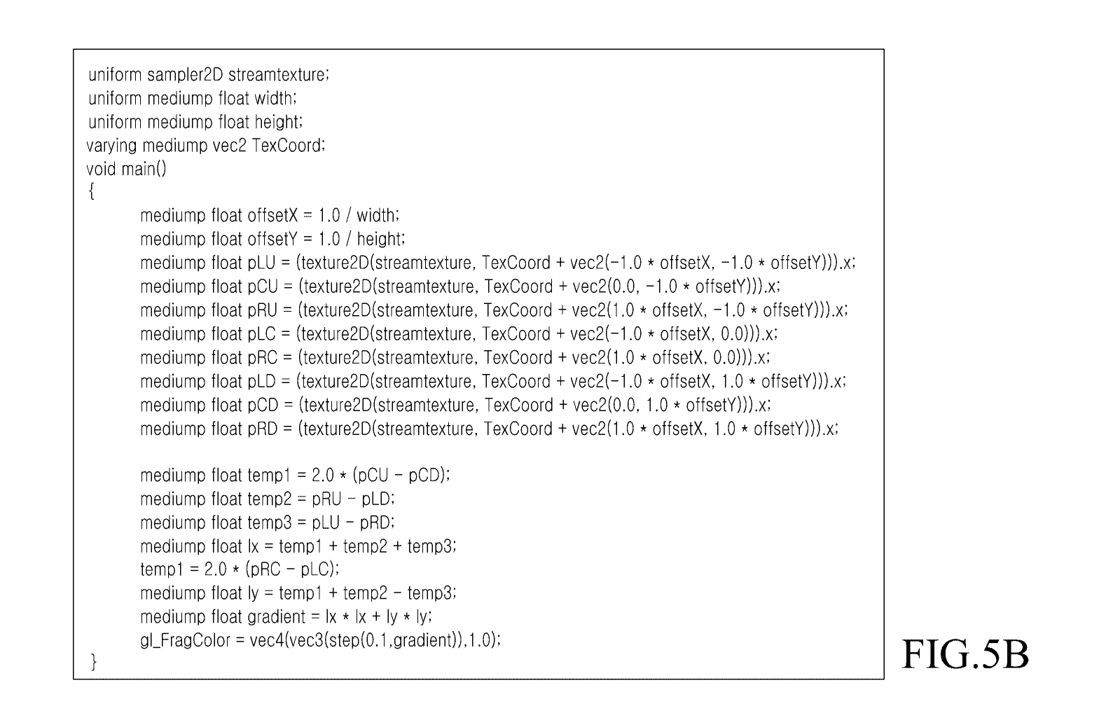

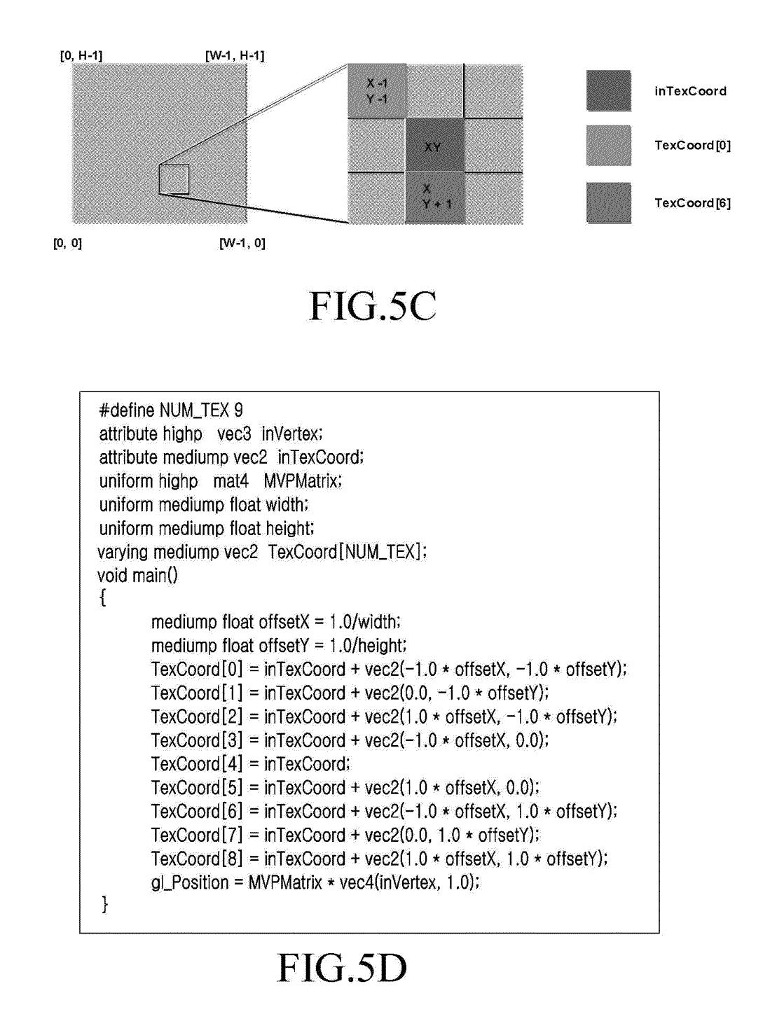

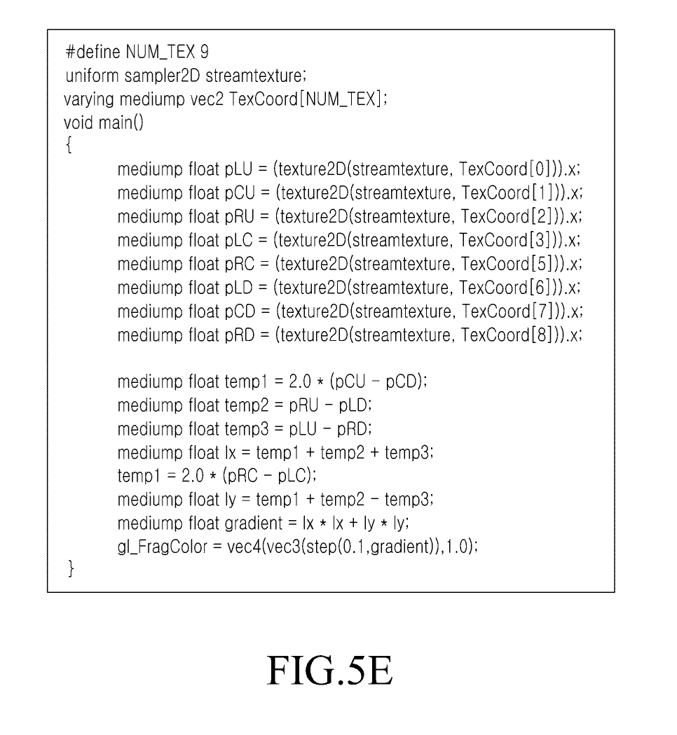

FIG. 5A illustrates a process of performing Sobel edge detection through a handheld device to which an image processing method according to an embodiment of the present invention is applied, and FIG. 5B illustrates an example of a program code input into the fragment processor 153 of a GPGPU provided in the handheld device of FIG. 5A.

Referring first to FIG. 5A, an original image 501 is input through the input buffer 131, and RGB-Gray processing for the original image is performed in Step 502 through the GPGPU 150. That is, the input original image 501 is converted into a quadrilateral image in a texture format through the texture converter 133 and the quadrilateral image generator 134 of the CPU 130. Further, the vertex processor 151 of the GPGPU 150 transforms each vertex included in the quadrilateral image into the image coordinate system. The fragment processor 153, which is compiled as a fragment shader implemented in the OpenGL ES shading language, as illustrated in FIG. 3D, extracts the color of each pixel from an input image in a texture format, and converts the extracted color to a brightness value. Here, the fragment processor 153, which is implemented as a state-machine function, stores the converted result 503 in the frame buffer 154. Further, the fragment processor 153, which is compiled as a fragment shader implemented in the OpenGL ES language, as illustrated in FIG. 5B, processes Sobel edge detection in Step 504 for the image stored in the frame buffer 154. An edge detection frame 505 is generated through the Sobel edge detection, and a result thereof is output to the display unit 123 through the screen buffer 135.

The GPGPU 150 may employ a unified shader architecture in which a vertex shader and a fragment shader are unified. The unified shader architecture may have a great influence on load balancing, and specifically, may be implemented such that more fragment processing cycles can be performed due to a reduction in vertex processing. In a typical image processing algorithm, vertex processing is relatively simple to implement, and fragment processing is relatively more complex to implement. Accordingly, if neighboring texture addresses are preprocessed in a vertex processor, then the cycle count of a fragment processor can be significantly reduced.

FIG. 5C illustrates a relation between input and output coordinates of a vertex processor, FIG. 5D illustrates an example of a program code input into the vertex processor 151 of the GPGPU provided in the handheld device of FIG. 5A, and FIG. 5E illustrates another example of a program code input into the fragment processor 153 of the GPGPU provided in the handheld device of FIG. 5A.

As described above, the vertex processor 151 may be implemented in such a manner as to be compiled as a vertex shader implemented in the OpenGL ES language, as illustrated in FIG. 5D, to thereby preprocess neighboring texture addresses according to the relation illustrated in FIG. 5C, and the fragment processor 153 may be implemented in such a manner as to be compiled as a fragment shader implemented in the OpenGL ES language, as illustrated in FIG. 5E, to thereby process Sobel edge detection.

When the fragment processor 153, which is compiled as a fragment shader implemented in the OpenGL ES language, as illustrated in FIG. 5B, processes Sobel edge detection, the fragment processor 153 achieves an image processing throughput of 13 fps (frames per second) at the VGA resolution, and has a cycle count of 39. However, when the vertex processor, which is compiled as a vertex shader implemented in the OpenGL ES language, as illustrated in FIG. 5D, preprocesses neighboring texture addresses, and the fragment processor 153, which is compiled as a fragment shader implemented in the OpenGL ES language, as illustrated in FIG. 5E, processes Sobel edge detection, the fragment processor 153 achieves an image processing throughput of 27 fps at the VGA resolution, and the cycle count thereof can be significantly reduced to 21.

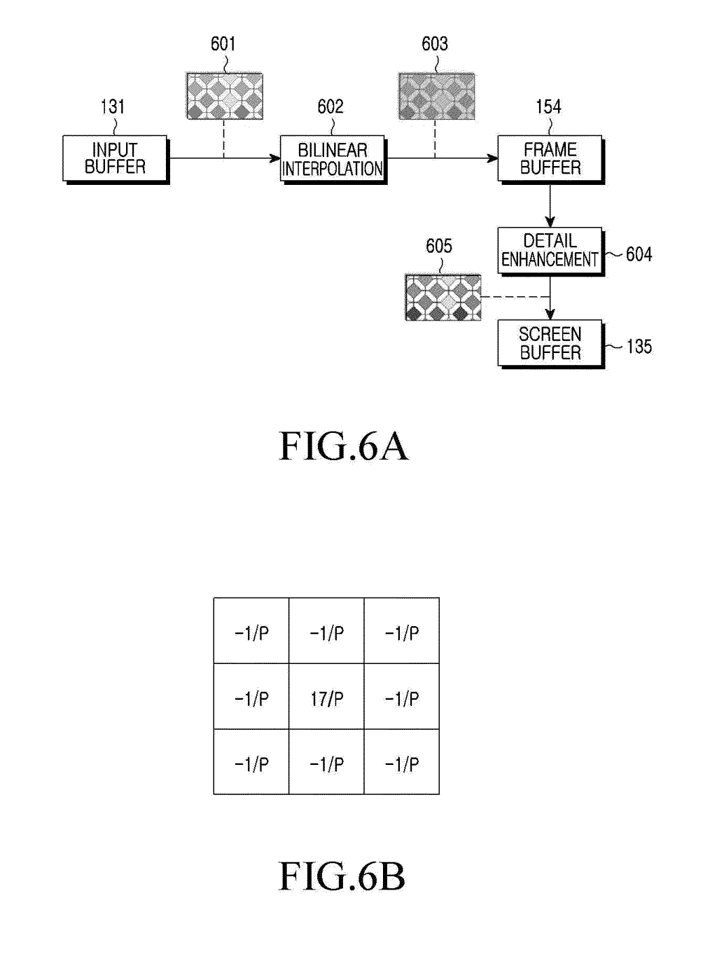

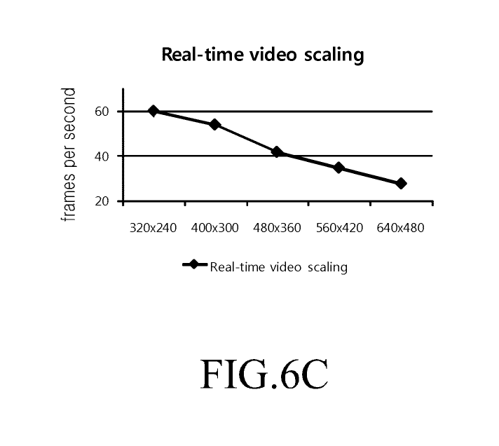

FIG. 6A illustrates a process of performing real-time video scaling with detail enhancement through a handheld device to which an image processing method according to an embodiment of the present invention is applied. Referring to FIG. 6A, in order to perform real-time video scaling with detail enhancement, an original image 601 is input through the input buffer 131, and the input original image is converted into a quadrilateral image in a texture format through the texture converter 133 and the quadrilateral image generator 134 of the CPU 130. Further, the vertex processor 151 of the GPGPU 150 transforms each vertex included in the quadrilateral image into the image coordinate system. The fragment processor 153 performs bilinear interpolation in Step 602 for the original image 601 according to a predetermined algorithm, and stores the bilinear-interpolated image 603 in the frame buffer 154. Further, in Step 604 the fragment processor 153 generates a detail-enhanced image 605 by applying weights for use in bilinear interpolation, as illustrated in FIG. 6B, to the bilinear-interpolated image 603, and outputs the detail-enhanced image 605 to the display unit 123 through the screen buffer 135.

Accordingly, the image quality of rendered textures can be quickly processed in real time by performing bilinear interpolation and detail enhancement. In addition, FIG. 6C illustrates the number of frames processed per second for different resolutions.

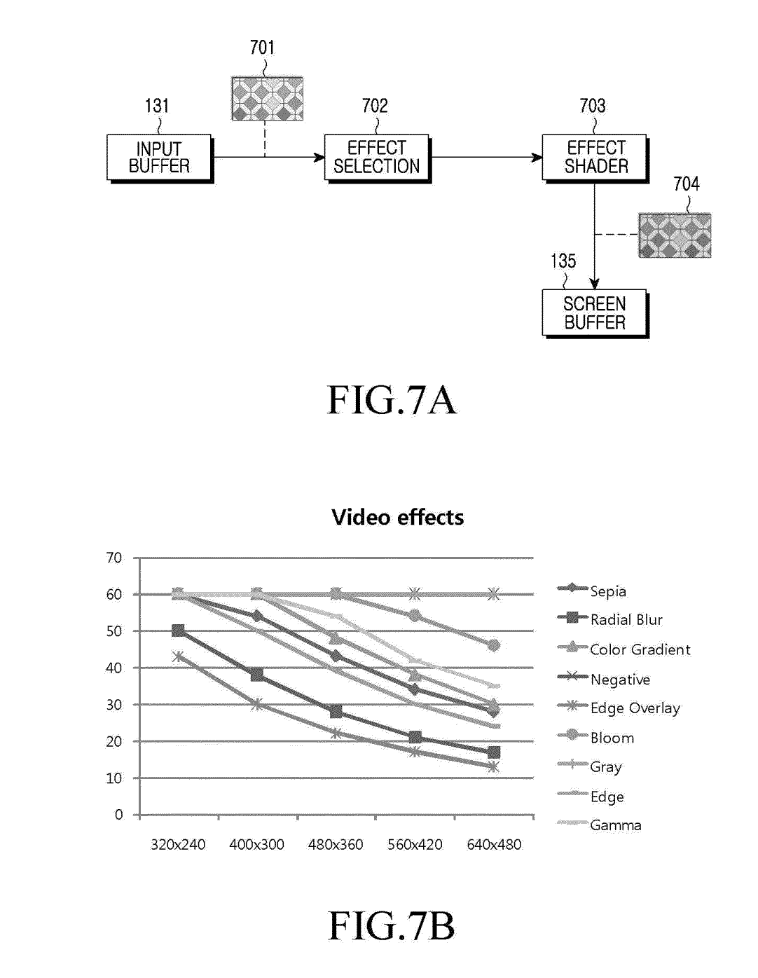

FIG. 7A illustrates a process of implementing real-time video effects through a handheld device to which an image processing method according to an embodiment of the present invention is applied. Referring to FIG. 7A, in order to implement real-time video effects, an original image 701 is input through the input buffer 131, and at least one effect is selected from a user through the application processor 132 of the CPU 130, in Step 702. Subsequently, the input original image 701 is converted into a quadrilateral image in a texture format through the texture converter 133 and the quadrilateral image generator 134 of the CPU 130. Further, the vertex processor 151 of the GPGPU 150 transforms each vertex included in the quadrilateral image into the image coordinate system. The fragment processor 153 performs effect shader processing in Step 703 for the original image 701 according to a predetermined algorithm, and outputs an effect frame 704 to the screen buffer 135. Examples of the real-time video effects include sepia, radial blur, negative, color gradient, bloom, edge overlay, gray, gamma, edge, and the like in common use. In addition, FIG. 7B illustrates the number of frames processed per second in each real-time video effects processing for different resolutions.

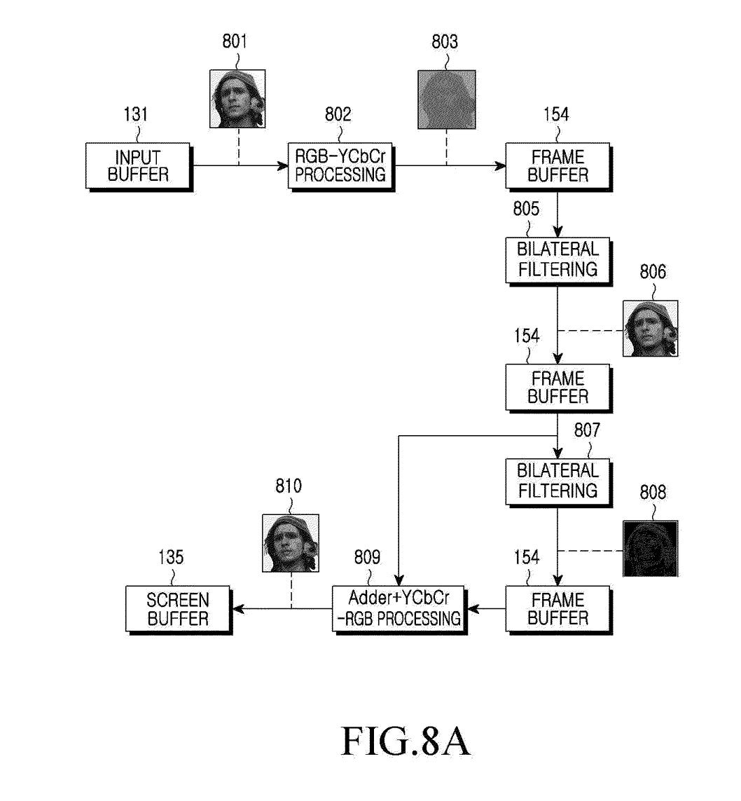

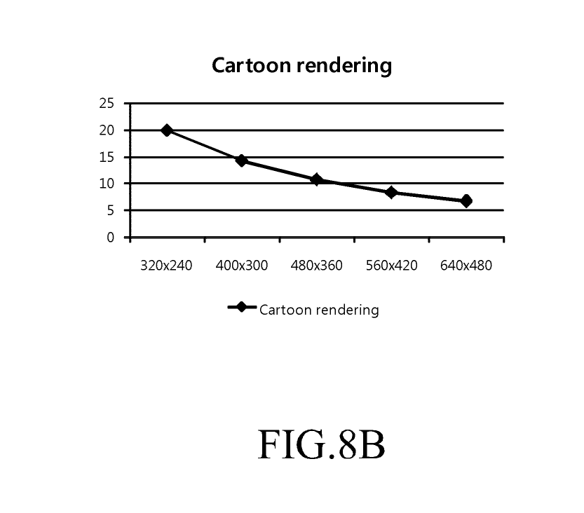

FIG. 8A illustrates a process of performing cartoon-style non-photorealistic rendering through a handheld device to which an image processing method according to an embodiment of the present invention is applied. Referring to FIG. 8A, in order to perform cartoon-style non-photorealistic rendering, an original image 801 is input through the input buffer 131, and the input original image 801 is converted into a quadrilateral image in a texture format through the texture converter 133 and the quadrilateral image generator 134 of the CPU 130. Further, the vertex processor 151 of the GPGPU 150 transforms each vertex included in the quadrilateral image into the image coordinate system. The fragment processor 153 performs RGB-YCbCr conversion processing in Step 802 according to a predetermined algorithm, and outputs the converted image 803 to the frame buffer 154. Subsequently, the fragment processor 153 reads the converted image 803 from the frame buffer 154, performs bilateral filtering in Step 805 for the converted image 803, and outputs the filtered image 806 to the frame buffer 154. Further, the fragment processor 153 reads the filtered image 806 again from the frame buffer 154, performs bilateral filtering in Step 807 for the filtered image 806, and outputs the edge-detected image 808 to the frame buffer 154. Further, the fragment processor 153 reads the filtered image 806 and the edge-detected image 808 from the frame buffer 154, performs adder and YCbCr-RGB conversion processing in Step 809 to generate a cartoon-style-non-photorealistic rendered image 810, and outputs the generated image 810 to the screen buffer 135. In addition, FIG. 8B illustrates the number of frames processed per second in cartoon-style non-photorealistic rendering processing for different resolutions.

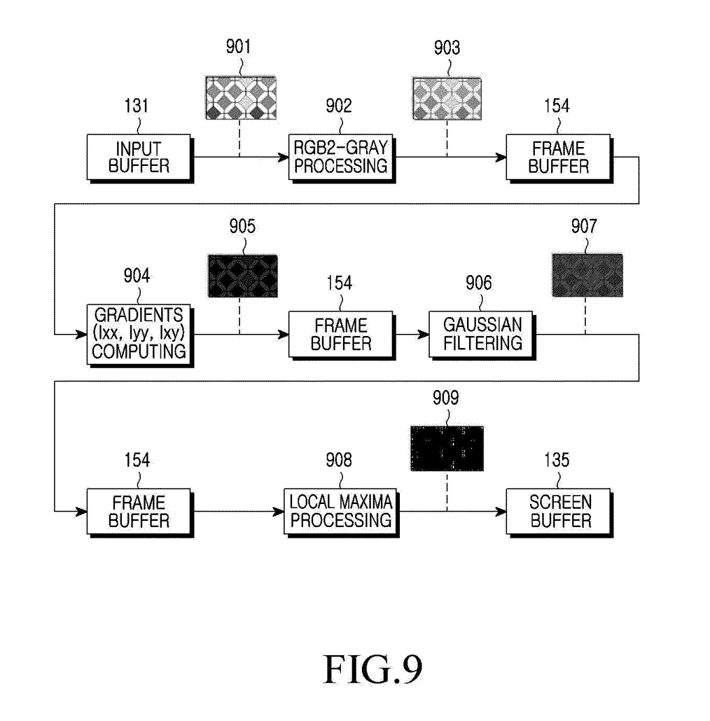

FIG. 9 illustrates a process of implementing a Harris corner detector in a handheld device to which an image processing method according to an embodiment of the present invention is applied. Referring to FIG. 9, in order to implement a Harris corner detector, an original image 901 is input through the input buffer 131, and the input original image 901 is converted into a quadrilateral image in a texture format through the texture converter 133 and the quadrilateral image generator 134 of the CPU 130. Further, the vertex processor 151 of the GPGPU 150 transforms each vertex included in the quadrilateral image into the image coordinate system. The fragment processor 153 performs RGB-Gray conversion processing in Step 902 for the original image 901, and outputs the converted image 903 to the frame buffer 154. Subsequently, the fragment processor 153 reads the converted image 903 stored in the frame buffer 154, executes a gradient computation in Step 904 on the converted image 903, and outputs the gradient-computed image 905 to the frame buffer 154. Further, the fragment processor 153 reads the gradient-computed image 905 again from the frame buffer 154, performs Gaussian filtering in Step 906, and outputs the filtered image 907 to the frame buffer 154. Further, the fragment processor 153 reads the filtered image 907 from the frame buffer 154, executes a local maxima computation in Step 908 on the filtered image 907 to generate a Harris corner-detected image 909, and outputs the Harris corner-detected image 909 to the screen buffer 135. For example, the local maxima computation may be executed by the following Equation (1):

H(x,y)=det(c)−α(trace(c))², H≧0, iƒ0≦α≦0.25 (1)

In Equation (1), α is a parameter, and c is a value obtained by the following Equation (2):

$$c = w ( γ \cdot σ ) * [ \begin{matrix}{f}_{x}^{2} & {f}_{x} {f}_{y} \\ {f}_{x} {f}_{y} & {f}_{y}^{2}\end{matrix} ] \qquad ( 2 )$$

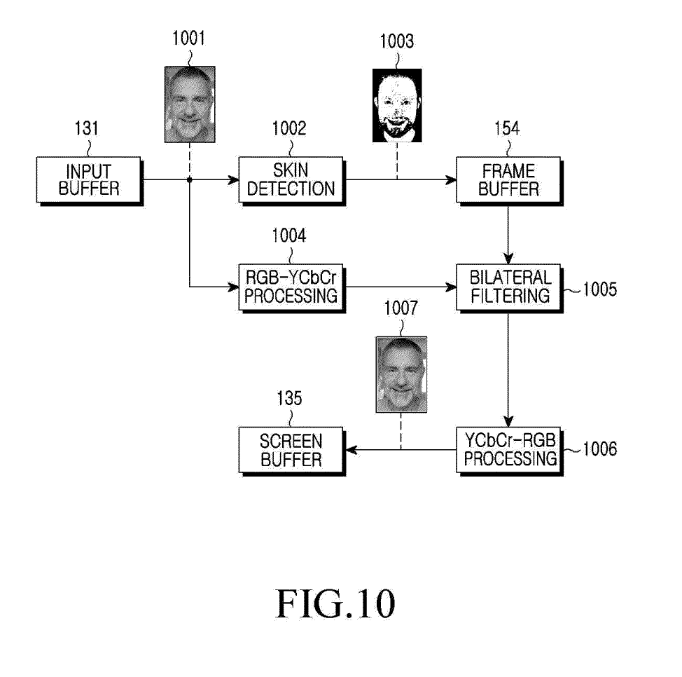

FIG. 10 illustrates a process of performing face image beautification through a handheld device to which an image processing method according to an embodiment of the present invention is applied. Referring to FIG. 10, in order to perform face image beautification, an original image 1001 is input through the input buffer 131, and the input original image 1001 is converted into a quadrilateral image in a texture format through the texture converter 133 and the quadrilateral image generator 134 of the CPU 130. Further, the vertex processor 151 of the GPGPU 150 transforms each vertex included in the quadrilateral image into the image coordinate system. The fragment processor 153 generates a skin-detected image 1003 by applying a skin detection algorithm in Step 1002 to the original image 1001, and outputs the skin-detected image 1003 to the frame buffer 154. Further, the GPGPU 150 performs RGB-YCbCr conversion processing in Step 1004 for the original image 1001, performs bilateral filtering in Step 1005 for the skin-detected image 1003 read from the frame buffer 154, and then performs YCbCr-RGB conversion processing again in Step 1006. The fragment processor 1007 generates a beautified image 1007 through the above Steps 1002, 1004, 1005, and 1006, and outputs the beautified image 1007 to the screen buffer 135.

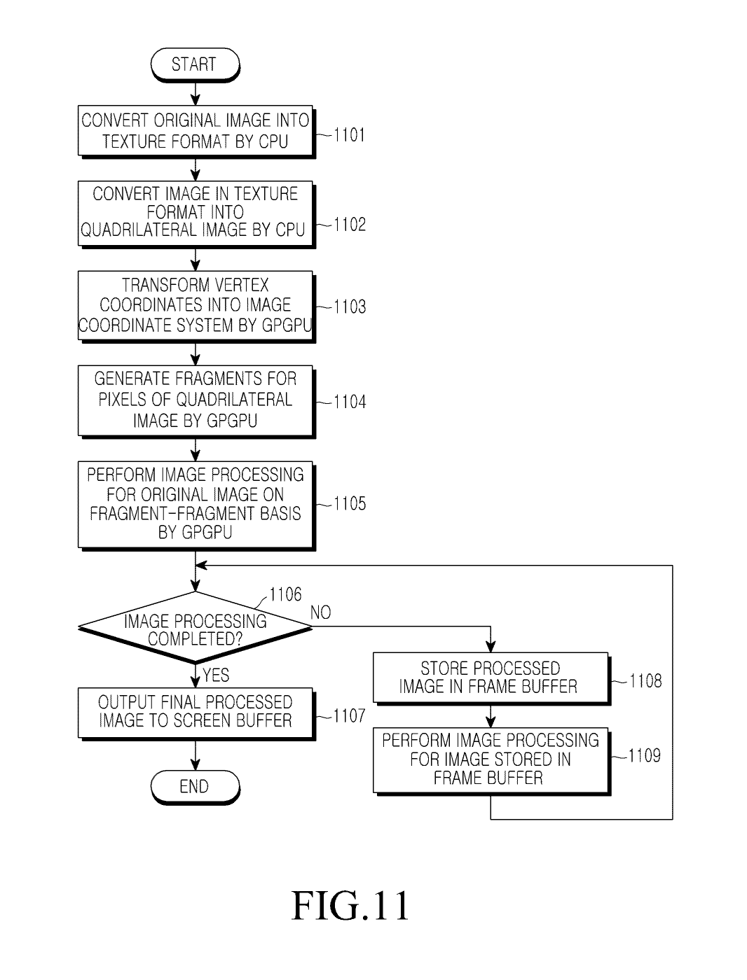

FIG. 11 illustrates a procedure of performing an image processing method in a handheld device according to an embodiment of the present invention.

Referring to FIG. 11, in Step 1101, the CPU converts an original image, input from the external camera module or the memory, into a texture format. Next, in Step 1102, the CPU converts the image in a texture format into a quadrilateral image in consideration of the display size and the image resolution, such that the converted quadrilateral image matches to the display size and the image resolution. Also, the CPU outputs the quadrilateral image along with a request for image processing for the original image to the GPGPU.

The CPU may further generate data to be output to the display by processing a predetermined application. Thus, in Step 1102, the CPU may combine the data, generated by processing the predetermined application, with the original image. More specially, Step 1102 includes a step in which the CPU generates data to be output to the display by processing a predetermined application, and converts the data into a texture format. Step 1102 may further include a step in which the CPU combines the original image in a texture format with the data to be output to the display, and then converts the combined image into a quadrilateral image.

In Step 1103, the GPGPU transforms vertices included in the quadrilateral image from the global coordinate system to the image coordinate system. In Step 1104, the GPGPU identifies an area formed by four vertices included within the image coordinate system, and sets fragments for pixels included in the identified area. For example, each pixel included in the area may be set as each fragment.

Next, in Step 1105, the GPGPU performs image processing for the original image by a predetermined shader. The GPGPU matches the original image to the fragments, and performs image processing for each fragment. The predetermined shader includes a program source code (that is, fragment shader program source code) or binary that specifies in detail operators to be executed on fragments, and may be, for example, a fragment shader implemented in the OpenGL ES shading language. The predetermined shader may be provided to the GPGPU in the process of outputting the request for image processing for the original image from the CPU to the GPGPU in Step 1102.

To achieve high throughput, OpenGL ES 2.0 (version 2.0 of the OpenGL ES language) supports three precision modifiers (lowp, mediump, highp). The highp modifier is represented as 32 bit floating point values, the mediump modifier is represented as 16 bit floating point values in the range [−65520, 65520], and the lowp modifier is represented as 10 bit fixed point values in the range [−2, 2]. The lowp modifier is useful to represent color values and any data read from low precision textures. Selecting a low precision can increase the performance of a handheld device, but may cause overflow. Accordingly, the predetermined shader should keep an appropriate balance therebetween, at which the performance of a handheld device can be maximized within a range not causing overflow.

Further, in a typical image processing algorithm, vertex processing is relatively simple to implement, and fragment processing is relatively more complex to implement. Accordingly, image processing is implemented such that neighboring texture addresses are preprocessed in a vertex processor.

Further, the image processing may be implemented as a method-call function with a single rendering pass or a state-machine function with multi-pass rendering cycles. When the image processing is implemented as a method-call function, an image-processed image is provided to the screen buffer of the CPU. Contrarily, when the image processing is implemented as a state-machine function, a plurality of rendering processing for the original image is performed, and an intermediate output value, generated in each rendering cycle, is stored in a texture format in the frame buffer of the GPGPU. Accordingly, in Step 1106, the GPGPU checks whether the image processing is completed or additional image processing is required. When the image processing is completed, the GPGPU proceeds to Step 1107, and outputs the final image-processed image to the screen buffer. Contrarily, when the image processing is not completed, and additional image processing is required, the GPGPU proceeds to Step 1108, and stores the image-processed image in the frame buffer. Further, the GPGPU reads the image stored in the frame buffer, performs image processing for the image in Step 1109, and then returns to step 1106.

According to the present invention as described above, image processing for an image can be performed in real time by using a GPGPU provided in a handheld device.

Further, image processing can be quickly and accurately performed using a programmable shader that is optimized for image processing performed by a GPGPU.

While the invention has been shown and described with reference to embodiments thereof, it will be understood by those skilled in the art that various changes in form and detail may be made therein without departing from the spirit and scope of the invention as defined by the appended claims.

What is claimed is:

1. A handheld device comprising:
a Central Processing Unit (CPU) for receiving an original image input into the handheld device, and converting the original image into a quadrilateral image corresponding to a display size; and
a General Purpose Computing on Graphics Processing Unit (GPGPU) for setting fragments for pixels included within vertices of the quadrilateral image, and applying a predetermined algorithm for image processing to the original image.

2. The handheld device as claimed in claim 1, wherein the CPU comprises:
a texture converter for converting the original image into a texture format; and
a quadrilateral image generator for converting the texture format-converted image into a quadrilateral image.

3. The handheld device as claimed in claim 1, wherein the CPU further comprises an application processor for processing a predetermined application, and outputting an image or text to be displayed on a display, and the texture converter converts the image or text output from the application processor, along with the original image, into a texture format.

4. The handheld device as claimed in claim 1, wherein the GPGPU comprises:
a vertex processor for transforming vertices included in the quadrilateral image into an image coordinate system;
a rasterizer for generating fragments for pixels included in an area formed by the vertices; and
a fragment processor for receiving a predetermined algorithm input from the CPU, and processing and outputting the original image on a fragment-by-fragment basis according to the predetermined algorithm.

5. The handheld device as claimed in claim 4, wherein the GPGPU further comprises a frame buffer for storing data output from the fragment processor on a fragment-by-fragment basis, and the fragment processor further processes and outputs the data stored in the frame buffer according to the predetermined algorithm.

6. A method of processing an image in a handheld device, the method comprising the steps of:
receiving an original image input into the handheld device, and converting the original image into a quadrilateral image corresponding to a display size;
setting fragments for pixels included within vertices of the quadrilateral image by a general purpose computing on graphics processing unit (GPGPU); and
performing image processing for each fragment of the original image by the GPGPU.

7. The method as claimed in claim 6, wherein converting the original image into the quadrilateral image comprises:
converting the original image into a texture format; and
a quadrilateral image generator for converting the texture format-converted image into a quadrilateral image.

8. The method as claimed in claim 7, further comprising:
processing a predetermined application, and outputting an image or text to be displayed on a display,
converting the output image or text into a texture format; and
combining the texture format-converted original image with the texture format-converted image or text.

9. The method as claimed in claim 6, wherein setting the fragments comprises:
transforming vertices included in the quadrilateral image into an image coordinate system; and
generating fragments for pixels included in an area formed by the vertices; and

10. The method as claimed in claim 6, wherein performing the image processing comprises:
inputting a predetermined algorithm for the image processing;
inputting fragments for the original image and the quadrilateral image; and
processing the original image on a fragment-by-fragment basis according to the predetermined algorithm.

11. The method as claimed in claim 10, wherein processing the original image on a fragment-by-fragment basis comprising:
processing the original image on a fragment-by-fragment basis according to the predetermined algorithm, and storing data corresponding to the processed original image in a frame buffer object; and
further processing and outputting the data stored in the frame buffer object according to the predetermined algorithm.
